(19) United States
(12) Patent Application Publication
(10) Pub. No.: US 2022/0219726 A1
(43) Pub. Date: Jul. 14, 2022

(54) SYSTEMS, METHODS, AND MEDIA FOR EVALUATION OF TRAJECTORIES AND SELECTION OF A TRAJECTORY FOR A VEHICLE

(71) Applicants: Peyman YADMELLAT, North York (CA); Kasra REZAEE, Kitchener (CA)

(72) Inventors: Peyman YADMELLAT, North York (CA); Kasra REZAEE, Kitchener (CA)

(21) Appl. No.: 17/147,256

(22) Filed: Jan. 12, 2021

(51) Int. Cl. B60W 60/00; G01C 21/34

(52) U.S. Cl. CPC B60W 60/0011; B60W 60/0013; B60W 2720/106; G01C 21/3453; B60W 2520/105; B60W 60/0021

(57) ABSTRACT

Systems, methods and computer-readable media for selecting a trajectory for an autonomous vehicle are disclosed. A trajectory evaluator may be used to sort candidate trajectories according to criteria associated with a plurality of objectives. Criterion satisfaction data is generated for each candidate trajectory for each objective, indicating whether the criterion is likely to be satisfied by the candidate trajectory. Criteria are ranked by priority, which determines the sorting order. Candidate trajectories that satisfy similar criteria may be grouped into a common category, and candidate trajectories within each category may be sorted according to a cost function. The cost function may be a single universal cost function applied to all categories, or may be selected from a plurality of cost functions based on the criterion satisfaction data of the trajectories being sorted, such as a cost function specific to each category.

### FIELD

The present disclosure is related to systems, methods, and computer-readable media for evaluation of trajectories and selection of a trajectory for a vehicle.

### BACKGROUND

An autonomous vehicle (e.g. a self-driving car) is a vehicle that includes different types of sensors to sense an environment surrounding the vehicle and operating parameters of the vehicle (e.g. speed, acceleration, etc.) and is capable of operating itself safely without any human intervention. An autonomous vehicle typically includes various software systems for perception and prediction, localization and mapping, as well as for planning and control. The software system for planning (generally referred to as a planning system) plans a trajectory for the vehicle to follow based on target objectives, the vehicle's surrounding environment, and physical parameters of the vehicle (e.g. wheelbase, vehicle width, vehicle length, etc.). A software system for control of the vehicle (e.g. a vehicle control system) receives the trajectory from the planning system and generates control commands to control operation of the vehicle to follow the trajectory.

The planning system may include multiple planners (which may also be referred to as planning units, planning sub-systems, planning modules, etc.) arranged in a hierarchy. The planning system generally includes: a mission planner, a behavior planner, and a motion planner. The motion planner receives as input a planned behavior for the autonomous vehicle generated by the behavior planner as well as information about the environment and information about the vehicle, performs motion planning to generate a trajectory for the autonomous vehicle, and outputs the trajectory for the autonomous vehicle to follow. In the present disclosure, a trajectory is a sequence, over multiple time steps, of a spatial position for the autonomous vehicle (in a geometrical coordinate system) and other parameters. Other parameters may include vehicle orientation, vehicle velocity, vehicle acceleration, vehicle jerk or any combination thereof.

Some approaches to motion planning involve the operations of trajectory generation, trajectory evaluation, trajectory sorting, and trajectory selection. Trajectory generation typically involves generating all possible trajectories for the autonomous vehicle. Trajectory generation may use some a priori knowledge (e.g., vehicle kinodynamic parameters) to only generate reasonable trajectories in order to reduce the number of generated trajectories that are to be evaluated. Trajectory evaluation typically involves evaluating the generated trajectories (e.g., using some quantitative metrics) to compare the trajectories and trajectory sorting typically involves sorting or ranking the generated trajectories by the degree to which they satisfy of one or more objectives. Trajectory selection typically involves selecting a desired trajectory from the generated trajectories based on the evaluation and sorting of the generated trajectories. The operations of trajectory generation, trajectory evaluation, trajectory sorting and trajectory selection are typically performed by a motion planner, and the operations can follow an iterative process wherein the trajectories generated by the trajectory generation are refined based on the set of sorted trajectories that are the output of the trajectory evaluation and sorting operations.

The objectives used by a trajectory evaluation operation may include objectives related to safety, comfort, and mobility (i.e. moving the vehicle toward its destination). Existing rule-based motion planning techniques typically require evaluation (e.g., comparison and sorting) of the generated trajectories according to explicitly defined cost functions that may take into account various objectives to calculate a cost associated with each trajectory being compared. The trajectories being compared may then be sorted by their associated estimated costs. A typical cost function is computed by combining weighted costs associated with the various objectives into an overall cost function. For example, a cost function in a conventional trajectory evaluator may consider the objectives (comfort, safety, mobility) in determining a cost function. Each objective is associated with a respective quantified cost (C_{comfort}, C_{safety}, C_{mobility}) and combined with respective weights (w_{comfort}, w_{safety}, w_{mobility}) to compute an overall cost for a given trajectory. Then the overall cost value would be optimized to select an optimal trajectory from the set of evaluated trajectories. The overall cost function can be represented as:

Cₜₒₜₐₗ=Σᵢwᵢ×Cᵢ, for i∈{comfort, safety, mobility} (Equation 1)

In this example, the weights (w_{comfort}, w_{safety}, w_{mobility}) define the importance of each objective. The weights can be adjusted by a system designer based on the priorities for a given design or application domain. For example, a designer tasked with configuring a trajectory evaluator for an autonomous semi-truck vehicle might wish to select a relatively conservative trajectory, leading the designer to select a relatively high weight for the safety objective, thereby prioritizing safety-related performance (e.g., maintaining greater distance from other objects in the traffic environment). Similarly, a designer seeking to configure a trajectory evaluator for an autonomous passenger bus vehicle might wish to select a relatively high weight for the comfort objective, thereby prioritizing a more comfortable ride (e.g., reducing acceleration and deceleration), whereas a designer seeking to configure a trajectory evaluator for an autonomous sports car vehicle might wish to select a relatively high weight for the mobility objective.

Such approaches use an overall cost function that combines the objectives with different weights may be effective in achieving the various objectives, but their behavior is not always predictable and in certain situations it can lead to undesired behavior. For example, increasing the weight of the comfort objective in the passenger bus example above might undermine the safety objective and choose a trajectory that has an unintendedly high probability of resulting in a collision. In addition, when there are many constraints and desires informing the design, choosing the right weights and properly quantifying each objective may be extremely challenging. At high degrees of complexity in design priorities, it may be impossible to guarantee that the results of the trajectory evaluator, and therefore the motion planner, will accord with the desires of the designer.

Accordingly, it would be useful to provide an approach to motion planning for autonomous vehicles that overcomes one or more of the limitations in trajectory evaluation and selection described above.

### SUMMARY

In various aspects, the present disclosure provides systems, methods and computer-readable media for evaluating trajectories for an autonomous vehicle generated by a motion planner of the autonomous vehicle and for selecting a desired trajectory from the evaluated trajectories for an autonomous vehicle to follow by sorting candidate trajectories according to criteria associated with a plurality of objectives. A trajectory evaluator may be used to generate criterion satisfaction data for each candidate trajectory for each objective, the criterion satisfaction data indicating whether the criterion is likely to be satisfied by the candidate trajectory. Criteria are ranked by priority rank, which determines the sorting order. Candidate trajectories that satisfy similar criteria may be grouped into a common category, and candidate trajectories within each category may be sorted according to a cost function. The cost function may be a single universal cost function applied to all categories, or may be selected from a plurality of cost functions based on the criterion satisfaction data of the trajectories being sorted, such as a cost function specific to each category.

In some aspects, the trajectory evaluator operates as a component of a motion planner along with a trajectory generator and a trajectory selector, as described above. The motion planner takes as input a command from a behavior planner as well as information about the vehicle and the traffic environment around the vehicle. The traffic environment information may be the processed output of perception, prediction, localization, and mapping operations. The motion planner outputs a trajectory, which may be a sequence of timestamped position coordinates and orientations that the vehicle needs to follow.

The trajectory evaluator receives as inputs the plurality of candidate trajectories (such as those generated by the trajectory generator) as well as a plurality of objectives. Each objective includes an associated criterion, and each criterion has a priority rank. Whereas a given candidate trajectory may fulfill an objective to a greater or lesser degree, thereby representing a soft constraint that may be factored into a cost function along with other factors, a criterion associated with an objective represents a hard constraint.

Both soft constraints (i.e. objectives) and hard constraints (i.e. criteria) may be factored into the trajectory evaluation and sorting operations performed by the trajectory evaluator. For example, a designer may configure the trajectory evaluator to ensure that a vehicle is safe, so the cost function should require that the trajectory be free from collision (i.e. maintaining at least 30 cm from other objects is a criterion related to safety), which as an example can be defined as getting closer than 30 cm to any other object. However, the designer may also desire that, where possible, the car maintains a greater distance from any object (i.e. distance from other objects is an objective related to safety). For a comfort objective, a vehicle may have a physical deceleration limit based on the engine, tires and road condition (i.e., deceleration below the physical deceleration limit is a criterion related to comfort). However, the designer might also want to maintain the deceleration below a more conservative limit to provide a comfortable ride (i.e., slower deceleration is an objective related to comfort).

Aspects of the present disclosure described herein may provide an approach to evaluating and sorting trajectories that provides safe and robust motion planning, including greater flexibility in sorting and/or greater predictability in selecting a desired trajectory. By allowing a designer to define hard constraints (i.e. criteria) associated with one or more objectives that must be satisfied before sorting based on a multi-objective cost function, some aspects of the present disclosure may provide greater predictability in the behavior of the motion planner. Furthermore, the use of criteria as hard constraints may simplify the sorting process by allowing some candidate trajectories to be rejected at an early processing stage for failing to satisfy one or more criteria.

As used herein, the term “trajectory selector” may refer to any functional module that performs trajectory selection to select a desired trajectory based on trajectory evaluation and/or trajectory sorting operations performed by a trajectory evaluator. In some examples, the trajectory selector may be implemented as part of the trajectory evaluator, as described in greater detail below with reference to example embodiments.

In some aspects, the present disclosure provides a system for selecting a trajectory for an autonomous vehicle. The system comprises a processing system configured to execute instructions to cause the system to perform a number of operations. A plurality of candidate trajectories are received. For each of a plurality of objectives, a criterion related to the objective and a priority rank for the criterion are received. For each objective, criterion satisfaction data are generated for each candidate trajectory. The criterion satisfaction data indicate a likelihood that the candidate trajectory satisfies the criterion. The plurality of candidate trajectories are sorted to generate a sorted plurality of candidate trajectories. The sorted plurality of candidate trajectories are ordered based on the criterion satisfaction data and priority rank for each criterion. A candidate trajectory is selected based on the order of the sorted plurality of candidate trajectories.

In some aspects, the present disclosure provides a method for selecting a trajectory for an autonomous vehicle. A plurality of candidate trajectories are received. For each of a plurality of objectives, a criterion related to the objective and a priority rank for the criterion are received. For each objective, criterion satisfaction data are generated for each candidate trajectory. The criterion satisfaction data indicate a likelihood that the candidate trajectory satisfies the criterion. The plurality of candidate trajectories are sorted to generate a sorted plurality of candidate trajectories. The sorted plurality of candidate trajectories are ordered based on the criterion satisfaction data and priority rank for each criterion. A candidate trajectory is selected based on the order of the sorted plurality of candidate trajectories.

In any of the above aspects, the sorted plurality of candidate trajectories are further ordered based on a cost value generated by applying a cost function to each candidate trajectory.

In any of the above aspects, the plurality of candidate trajectories are sorted by sorting the plurality of candidate trajectories based on the criterion satisfaction data and priority rank of each criterion, and if the criterion satisfaction data of two candidate trajectories satisfies a similarity metric, sorting the two candidate trajectories relative to each other based on the cost function applied to each of the two candidate trajectories.

In any of the above aspects, the criterion satisfaction data for each objective comprises a binary value selected from a first value indicating that the criterion is satisfied, and a second value indicating that the criterion is not satisfied.

In any of the above aspects, the similarity metric is satisfied only by identical binary values for all objectives.

In any of the above aspects, the plurality of candidate trajectories are sorted by generating, for each candidate trajectory, a binary number comprising the binary value of each objective's criterion satisfaction data, ordered by the priority rank of each criterion; sorting the plurality of candidate trajectories into ordered categories based on an integer equivalent value of the binary number; and sorting the candidate trajectories within each category based on the cost function.

In any of the above aspects, the criterion satisfaction data for each objective comprises a membership value selected from a continuous range of membership values.

In any of the above aspects, the similarity metric is satisfied for a first candidate trajectory and a second candidate trajectory if, for each objective, the membership value for the first candidate trajectory is within a predetermined similarity range of the membership value for the second candidate trajectory.

In any of the above aspects, the cost function comprises a single universal cost function, the single universal cost function comprising a weighted sum of a plurality of objective costs, each objective costs being associated with one of the plurality of objectives.

In any of the above aspects, the cost function comprises a cost function selected from a plurality of cost functions based on the criterion satisfaction data.

In any of the above aspects, the plurality of objectives includes a safety objective, and the criterion of the safety objective comprises a minimum safe distance to an object.

In any of the above aspects, the plurality of objectives includes a comfort objective, and the criterion of the comfort objective comprises a maximum acceleration and a maximum deceleration.

In any of the above aspects, the plurality of objectives includes a mobility objective, and the criterion of the mobility objective comprises a minimum distance travelled toward a destination.

In some aspects, the present disclosure provides a computer-readable medium storing instructions for execution by a processing system of a system for selecting a trajectory for an autonomous vehicle. The instructions when executed cause the system to perform any of the aspects of the method described above.

### BRIEF DESCRIPTION OF THE DRAWINGS

Reference will now be made, by way of example, to the accompanying drawings which show example embodiments of the present application, and in which:

FIG. 1 is a block diagram illustrating some components of an example autonomous vehicle.

FIG. 2 is block diagram illustrating some components of a processing system that may be used to implement a planning system of the autonomous vehicle of FIG. 1 according to example embodiments.

FIG. 3 is a block diagram illustrating further details of an example planning system.

FIG. 4 is a Venn diagram showing the intersections of criteria associated with various objectives used by an example trajectory evaluator of the planning system of FIG. 3 to evaluate trajectories generated by the trajectory generator of FIG. 3.

FIG. 5A is a table of criterion satisfaction data for four candidate trajectories generated by a first example embodiment of a trajectory evaluator using binary values for criterion satisfaction data.

FIG. 5B is a table of criterion satisfaction data for the four candidate trajectories of FIG. 5A generated by a second example embodiment of a trajectory evaluator using continuous membership values for criterion satisfaction data.

FIG. 6 is a table of costs for the four candidate trajectories of FIGS. 5A-5B generated by an example embodiment of a trajectory evaluator using a cost function.

FIG. 7 is a flowchart illustrating an example method for selecting a trajectory for an autonomous vehicle, according to example embodiments described herein.

Similar reference numerals may have been used in different figures to denote similar components.

### DESCRIPTION OF EXAMPLE EMBODIMENTS

In various examples, the present disclosure describes systems, methods and computer-readable media for selecting a trajectory for an autonomous vehicle by sorting candidate trajectories according to criteria associated with a plurality of objectives. Some embodiments may perform a further sorting of candidate trajectories using a cost function that factors in weighted objective costs associated with each objective.

The systems, methods and computer-readable media of the present disclosure are described in the context of autonomous vehicles. As described above, an autonomous vehicle (e.g. a self-driving car) is a vehicle that includes different types of sensors to sense state information (e.g. an environment surrounding the vehicle and operating parameters of the vehicle (e.g. speed, acceleration, etc.)), and is capable of operating itself safely without any human intervention or with minimal human intervention in some circumstances. An autonomous vehicle typically includes various software systems for perception and prediction, localization and mapping, as well as for planning and control. The software system for planning (generally referred to as a planning system) plans a trajectory for the vehicle to follow based on target objectives and physical parameters of the vehicle (e.g. wheelbase, vehicle width, vehicle length, etc.). A software system for control of the vehicle (e.g. a vehicle control system) receives the trajectory from the planning system and generates control commands to control operation of the vehicle to follow the trajectory. Although examples described herein may refer to a car as the autonomous vehicle, the teachings of the present disclosure may be implemented in other forms of autonomous (including semi-autonomous) vehicles including, for example, trams, subways, trucks, buses, surface and submersible watercraft and ships, aircraft, drones (also referred to as unmanned aerial vehicles (UAVs)), warehouse equipment, manufacturing facility equipment, construction equipment, farm equipment, mobile robots such as vacuum cleaners and lawn mowers, and other robotic devices. Autonomous vehicles may include vehicles that do not carry passengers as well as vehicles that do carry passengers.

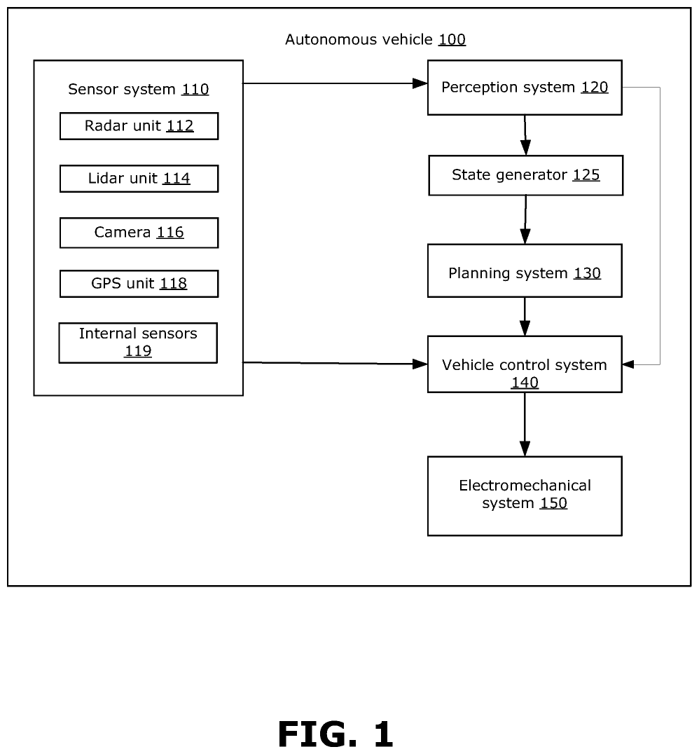

FIG. 1 is a block diagram illustrating certain components of an example autonomous vehicle 100.

The vehicle 100 includes a sensor system 110, a perception system 120, a state generator 125, a planning system 130, a vehicle control system 140 and an electromechanical system 150, for example. Other systems and components may be included in the vehicle 100 but are not shown for ease illustration. The perception system 120, the planning system 130, and the vehicle control system 140 in this example are distinct software systems that include machine readable instructions that may be executed by one or more processors in a processing system of the vehicle 100. Alternatively, the perception system 120, the planning system 130, and the vehicle control system 140 may be distinct systems on one or more chips (e.g., application-specific integrated circuit (ASIC), field-programmable gate array (FGPA), and/or other type of chip). For example, the perception system 120, the planning system 130, and the vehicle control system 140 may be implemented using one chip, two chips, or three distinct chips (using the same or different types of chips). Various systems and components of the vehicle may communicate with each other, for example through wired or wireless communication. For example, the sensor system 110 may communicate with the perception system 120 and the vehicle control system 140; the perception system 120 may communicate with the state generator 125; the state generator may communication with the planning system 130 and the vehicle control system 140; the planning system 130 may communicate with the vehicle control system 140; and the vehicle control system 140 may communicate with the electromechanical system 150.

FIG. 1 illustrates example flows of data (indicated by arrows) from the sensor system 110 to the perception system 120, to the planning system 130, to the vehicle control system 140, and to the electromechanical system 150 (discussed in further detail below). However, it should be understood that data may be communicated among the systems 110, 120, 125, 130, 140, 150 in various different ways, and there may be two-way data communication among the systems 110, 120, 125, 130, 140, 150.

The sensor system 110 includes various sensing units, such as a radar unit 112, a LIDAR unit 114, and a camera 116, for collecting information about an environment surrounding the vehicle 100 as the vehicle 100 operates in the environment. The sensor system 110 also includes a global positioning system (GPS) unit 118 for collecting information about a location of the vehicle in the environment. The sensor system 110 also includes one or more internal sensors 119 for collecting information about the physical operating conditions of the vehicle 100 itself, including for example sensors for sensing steering angle, linear speed, linear and angular acceleration, pose (pitch, yaw, roll), compass travel direction, vehicle vibration, throttle state, brake state, wheel traction, transmission gear ratio, cabin temperature and pressure, etc. Other sensors not shown in FIG. 1 may be included in the sensor system 110, such as environmental sensors for sensing external conditions such as an external temperature and pressure, precipitation, and noise, among other possibilities.

Information collected by each sensing unit of the sensor system 110 is provided as sensor data to the perception system 120. The perception system 120 processes the sensor data received from each sensing unit to generate data about the vehicle and data about the surrounding environment. Data about the vehicle includes, for example, one or more of data representing a vehicle location (e.g., including data about a position and orientation of the vehicle 100, which may be in absolute geographical longitude/latitudinal values and/or values that reference other frames of reference), data representing kinodynamic parameters, and data representing the physical parameters of the vehicle, such as width and length, mass, inertia, wheelbase, slip angle, cornering forces, and data about the motion of the vehicle, such as linear speed and acceleration, travel direction, angular acceleration, pose (e.g., pitch, yaw, roll), and vibration, and mechanical system operating parameters such as engine RPM, throttle position, brake position, and transmission gear ratio, etc.). Data about the surrounding environment may include, for example, information about detected stationary and moving objects around the vehicle 100, weather and temperature conditions, road conditions, road configuration and other information about the surrounding environment. For example, sensor data received from the radar, LIDAR and camera units 112, 114, 116 may be used to determine the local environment of the vehicle 100 (e.g., any immediately surrounding obstacles) as well as information from a wider vicinity (e.g., the radar unit 112 and LIDAR unit 114 may collect information from an area of up to 100 m radius or more around the vehicle 100). Sensor data from GPS unit 118 and other sensors may be used to determine the vehicle's location, defining a geographic position of the vehicle 100. Sensor data from internal sensors 119, as well as from other sensor units, may be used to determine the vehicle's kinodynamic parameters, including speed and pose (i.e. orientation) of the vehicle 100 relative to a frame of reference.

Generally, the term kinodynamic parameters refers to the parameters of a kinematic model and a dynamic model of a mechanical body which describe the motion of the body (position, orientation, acceleration, and jerk). In the context of the present disclosure, a kinematic model describes the motion of the vehicle 100 without considering the effects of the applied forces and torques to the motion of the vehicle 100 (e.g. describes the motion of the vehicle 100 without considering the mass, inertia, and frictions). A dynamic model describes the relationship between the applied forces and torques to the motion of the vehicle 100 (e.g. describes the effect of mass, inertia, tire slip angle, and tire forces in acceleration and orientation changes). In some embodiments, the kinodynamic parameters may include a distance of the front and rear axles to the centre of mass of the vehicle 100, the mass and inertia of the vehicle, vehicle geometry, tire forces at front and rear wheels of the vehicle 100, tire cornering stiffness, tire slip angle, and wheel size of the vehicle 100.

In some examples, the perception system 120 may also have access to a map (not shown), which may be a reference map that represents known information about the surrounding environment. For example, the map may be received from an external reference database (e.g., retrieved based on the vehicle's position, as determined using the GPS unit 118). The map may be used by the perception system 120 to assist in generating data about the physical environment, such as resolving ambiguities about the vehicle's location or the identity of sensed objects. The map may also be used by the planning system 130 described below to assist in planning a trajectory for the vehicle.

The perception system 120 in the present disclosure is described as a general system that performs various processing functions on the data about the vehicle 100 and the data about the environment. In some implementations, the perception system 120 may be implemented using various sub-systems for performing different functions. For example, the perception system 120 may provide the functions of sensor fusion (e.g. fusing the sensor data received from two or more sensing units), localization (e.g. using the map and sensor data from the GPS unit 118 and/or other sensing units to determine the geographic position of the vehicle 100), semantic understanding (e.g. using sensor data to identify the meaning of traffic signs, traffic signals, and other signifiers as part of the data about the environment), object detection and tracking (e.g. using sensor data to detect and track objects in the physical environment as part of the data about the environment), and/or processing a world model (e.g. a model of the environment that may be generated and/or compared to the data about the environment), among others. Some of these functions may be implemented using different sub-systems (e.g., a fusion sub-system or a state estimator sub-system) within the perception system 120, in some practical implementations. The present disclosure refers to the perception system 120 in general, for simplicity, and without loss of generality. The data output by the perception system 120 may include data about the vehicle 100 and data about the environment that is minimally processed (e.g., normalized and/or filtered to remove noise). The perception system 120 may also perform more extensive processing of the data about the vehicle 100 and the data about the environment, for example to generate an Occupancy Grid Map (OGM) and predicted future OGMs, to detect and classify objects of interest (e.g., other vehicles, pedestrians, etc.), to detect position and speed of objects categorized by their class, to detect road lane markings and the position of the centre of lane, etc. Thus, the data output by the perception system 120 may include both analyzed (or estimated) data (e.g., OGMs and object classifications) about the environment as well as simple data about the vehicle 100 (e.g., vehicle speed, vehicle acceleration, etc.).

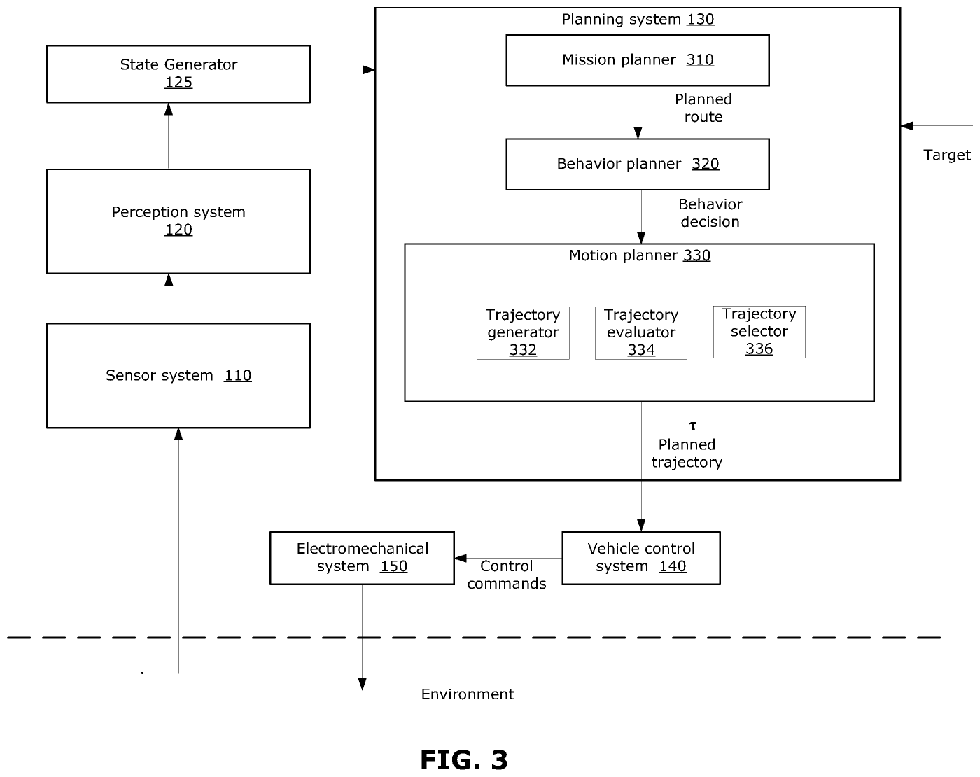

The data about the environment and the data about the vehicle 100 output by the perception system 120 is received by the state generator 125. The state generator 125 processes about the environment and the data about the vehicle 100 to generate a state for the vehicle 100 (hereinafter vehicle state). Although the state generator 125 is shown in FIG. 3 as a separate software system, in some embodiments, the state generator 125 may be included in the perception system 120 or in the planning system 130.

The vehicle state that is output from the state generator 125 in real-time to the planning system 130, which is the focus of the current disclosure and will be described in greater detail below. The vehicle control system 140 serves to control operation of the vehicle 100 based on the trajectory output by the planning system 130. The vehicle control system 140 may be used to generate control signals for the electromechanical components of the vehicle 100 to control the motion of the vehicle 100. The electromechanical system 150 receives control signals from the vehicle control system 140 to operate the electromechanical components of the vehicle 100 such as an engine, transmission, steering system and braking system.

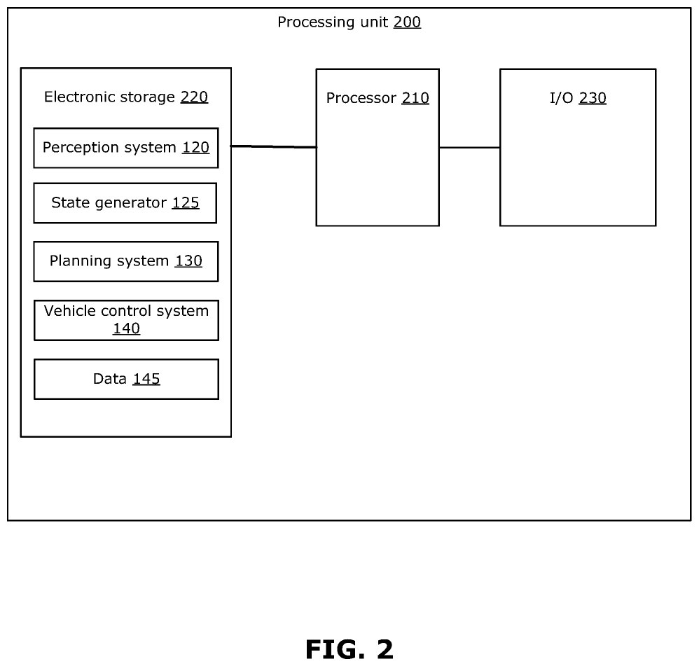

FIG. 2 shows illustrates an example of a processing system 200 that may be implemented in the vehicle 100. The processing system 200 includes one or more processors 210. The one or more processors 210 may include a central processing unit (CPU), a graphical processing unit (GPU), a tensor processing unit (TPU), a neural processing unit (NPU), a digital signal processor, and/or another computational element. The processor(s) 210 are coupled to an electronic storage 220 and to one or more input and output (I/O) interfaces or devices 230 such as network interfaces, user output devices such as displays, user input devices such as touchscreens, and so on. In some examples, the sensor system 110 and/or the electromechanical system 150 may be considered an input device and an output device respectively. The electronic storage 220 can include one or more non-transient or tangible memories (for example flash memory) and/or transient memories (for example RAM). The tangible memory(ies) may store instructions, data and/or software modules for execution by the processor(s) 210 to carry out the functions of the systems described herein. The tangible memory(ies) of the electronic storage 220 may store other software instructions and data for implementing other operations of the vehicle 100.

The electronic storage 220 may include any suitable volatile and/or non-volatile storage and retrieval device(s), including for example flash memory, random access memory (RAM), read only memory (ROM), hard disk, optical disc, subscriber identity module (SIM) card, memory stick, secure digital (SD) memory card, and other state storage devices. In the example of FIG. 2, the electronic storage 220 of the processing system 200 stores instructions (executable by the processor(s) 210) for implementing the perception system 120, the state generator 125, the planning system 130, and the vehicle control system 140. In some embodiments, the electronic storage 220 also stores data 145, including sensor data provided by the sensor system 110, the data about the vehicle and the data about the environment output by the perception system 120 utilized by the planning system 130 to generate at least one of trajectories, and other data such as the map.

FIG. 3 is a block diagram that illustrates further details of the planning system 130; some components of the vehicle 100 have been omitted for clarity.

The planning system 130 may perform planning and decision making operations. As described above, planning and decision making may be performed at three levels, namely at the mission level (e.g., mission planning performed by the mission planner 310), at the behavior level (e.g., behavior planning performed by the behavior planner 320) and at the motion level (e.g., motion planning performed by the motion planner 330).

Generally, the purpose of planning and decision making operations is to determine a path for the vehicle 100 to travel from a first position (e.g., the vehicle's current position and orientation, or an expected future position and orientation) to a target position (e.g., a final destination defined by the user). Planning and decision making operations may also include determining one or more trajectories to one or more intermediate target positions. The planning system 130 determines the appropriate path and trajectories with consideration of conditions such as the drivable ground (e.g., defined roadway), obstacles (e.g., pedestrians and other vehicles), traffic regulations (e.g., obeying traffic signals) and user-defined preferences (e.g., avoidance of toll roads).

Planning and decision making operations performed by the planning system 130 may be dynamic, i.e. they may be repeatedly performed as the environment changes. Thus, for example, the planning system 130 may receive a new vehicle state output by the state generator 125 and repeat the planning and decision making operations to generate a new plan and new trajectories in response to changes in the environment as reflected in the new vehicle state. Changes in the environment may be due to movement of the vehicle 100 (e.g., vehicle 100 approaches a newly-detected obstacle) as well as due to the dynamic nature of the environment (e.g., moving pedestrians and other moving vehicles).

As mentioned above, planning and decision making operations may be performed at different levels, for example at the mission level, behavior level and motion level. Mission planning is considered to be a higher (or more global) level of planning, motion planning is considered to be a lower (or more localized) level of planning, and behavior planning is considered to be a level between mission planning and motion planning. Generally, the output of planning and decision making operations at a higher level may form at least part of the input for a lower level of planning and decision making.

Planning and decision making operations performed at the mission level (e.g. mission planning performed by the mission planner 310) relate to planning a path for the vehicle 100 at a high, or global, level. The first position of the vehicle 100 may be the starting point of the journey (e.g., the user's home) and the target position of the vehicle 100 may be the final destination point (e.g., the user's workplace). Selecting a route to travel through a set of roads is an example of mission planning. Generally, the final destination point, once set (e.g., by user input) is unchanging through the duration of the journey. Although the final destination point may be unchanging, the path planned by mission planning may change through the duration of the journey. For example, changing traffic conditions may require mission planning to dynamically update the planned path to avoid a congested road. The user may also change the final destination point at any time during the journey.

Input data received by the mission planner 310 for performing mission planning may include, for example, GPS data (e.g., to determine the starting point of the vehicle 100), geographical map data (e.g., from an internal or external map database), traffic data (e.g., from an external traffic condition monitoring system), the final destination point (e.g., defined as x- and y-coordinates, or defined as longitude and latitude coordinates), as well as any user-defined preferences (e.g., preference to avoid toll roads).

The planned path generated by mission planning performed by the mission planner 310 and output by the mission planner 310 defines the route to be travelled to reach the final destination point from the starting point. The output may include data defining a set of intermediate target positions (or waypoints) along the route. The intermediate target positions may be defined at road intersections to indicate which road to take at each intersection, for example. The intermediate target positions may be used for planning at the behavior level (e.g., a planning and decision making operation (i.e. behavior planning) performed by the behavior planner 320) to decide the appropriate vehicle behavior).

The behavior planner 320 receives the planned route from the mission planner 310, including the set of intermediate target positions (if any). The behavior planner 320 also receives the vehicle state output by the state generator 125 and the physical parameters about the vehicle 100. The behavior planner 320 generates a behavior decision based on the planned route, the vehicle state, and the physical parameters about the vehicle 100, in order to control the behavior of the vehicle 100 on a more localized and short-term basis than the mission planner 310. The behavior decision may serve as a target or set of constraints for the motion planner 330. The behavior planner 320 may generate a behavior decision that is in accordance with certain rules or driving preferences. For example, the behavior planner 320 may generate a behavior decision that ensures that the vehicle 100 follows certain behavior rules (e.g., left turns should be made from the left-most lane, vehicle speed should be within a speed limit, vehicle should stop at a stop sign, etc.). Such behavior rules may be based on traffic rules, as well as based on guidance for smooth and efficient driving (e.g., vehicle should take a faster lane if possible). The behavior decision may be output by the behavior planner 320 in a variety of suitable formats. For example, the behavior planner 320 may output the behavior decision in the form of signals (such as a safety signal), scalar values, and/or a cost map (or cost image), among other possibilities. The behavior decision output from the behavior planner 320 may serve as constraints on motion planning, for example.

The behavior decision is received as input commands to the motion planner 330. For example, the input commands provided to the motion planner 330 (i.e. the behavior decision) may include motion planning constraints. The motion planner 330 should find a trajectory that satisfies the behavior decision, and that navigates the environment in a relatively safe, comfortable, and speedy way. The motion planner 330 should be designed to provide a safe and robust trajectory on both structured and unstructured environments. A structured environment is generally an environment having well-defined drivable and non-drivable areas (e.g., a highway having clear lane markings), and which may have defined driving rules that all vehicles are expected to follow. An unstructured environment is generally an environment in which drivable and non-drivable areas are less defined (or undefined) (e.g., an open field), and which may have fewer or no driving rules for expected vehicle behavior. Regardless of whether the environment is structured or unstructured, the environment may also be highly dynamic (e.g., pedestrians and other vehicles are each moving) and each dynamic obstacle may have different and independent behaviors. This makes the design of the motion planner 330 challenging.

In the example shown in FIG. 3, the motion planner 330 includes a trajectory generator 332, a trajectory evaluator 334, and a trajectory selector 336. The trajectory generator 332 may be implemented using various suitable approaches, for example using expert-designed equations (e.g., polynomials) that generate trajectories for the vehicle 100 based on the planned path output (or intermediate target positions) received from the mission planner 330, the behavior decision received from the behavior planner 320 and the current vehicle state received from the state generator 125. In some embodiments, the motion planner 330 may also receive predicted future vehicle states as input. The trajectory evaluator 334 receives as input the vehicle state, the planned path (or intermediate target positions), the vehicle kinodynamic parameters, and the candidate trajectories generated by the trajectory generator 332, and assigns an evaluation value to each candidate trajectory. The assigned evaluation value may be reflective of whether the candidate trajectory successfully achieves the goal of relatively safe, comfortable and speedy driving (and also satisfies the behavior decision), in accordance with various predetermined objectives. The trajectory selector 336 selects the candidate trajectory with the highest evaluation value (as assigned by the trajectory evaluator 334) among the candidate trajectories generated by the trajectory generator 332. In some embodiments, the candidate trajectories are sorted by the trajectory evaluator in order of evaluation value, such that the candidate trajectory with the highest evaluation value is first in sorted order.

Although the trajectory generator 332, the trajectory evaluator 334 and the trajectory selector 336 are shown and discussed herein as separate blocks (e.g., separate modules, or separate functions) implemented in the motion planner 330, it should be understood that two or more of the trajectory generator 332, trajectory evaluator 334 and trajectory selector 336 may be implemented together in a single block (e.g., within the same module, or algorithm). Whereas the example embodiments shown in the figures herein include a trajectory selector 336 implemented as a discrete functional module, in some embodiments the trajectory selector 336 may be unnecessary or may be trivially implemented as a final operation performed by the trajectory evaluator 334, which may simply select the trajectory sorted to the top of the list of trajectories ordered by, e.g., a desirability metric. Similarly, whereas the embodiments illustrated herein show a single trajectory evaluator 334 that performs trajectory evaluation and sorting operations, in other embodiments the trajectory evaluator 334 may be implemented as two separate functional modules: an evaluation module configured to evaluate each candidate trajectory (e.g., to assign each candidate trajectory one or more evaluation values), and a sorting module configured to sort the candidate trajectories as described herein.

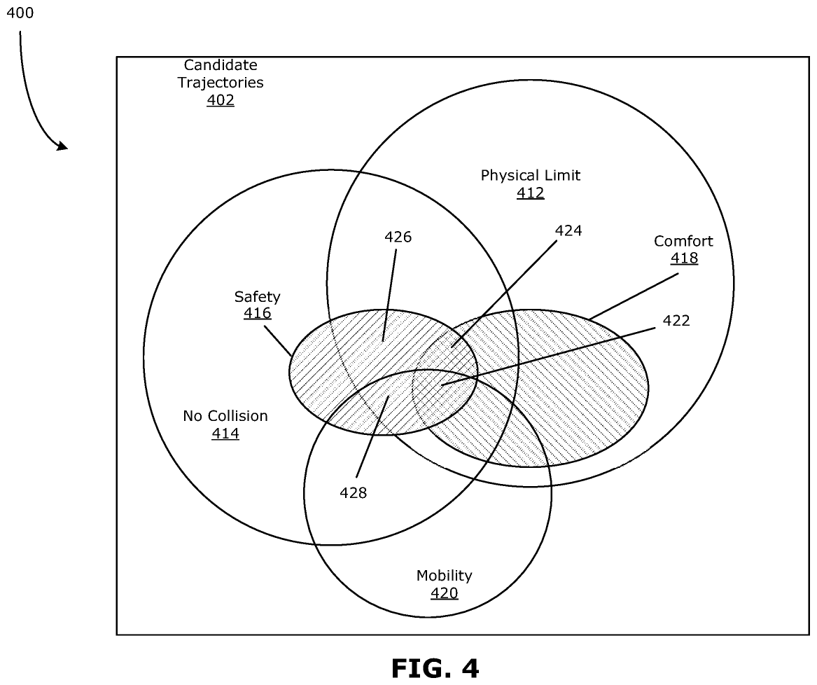

Example embodiments of the trajectory evaluator 334 will now be described in greater detail with reference to FIGS. 4-7.

The trajectory evaluator 334 in the present disclosure implements a rules-based trajectory evaluation operation for sorting candidate trajectories using a combination of hard constraints, called criteria, and soft constraints, called objectives, wherein each criterion is associated with an objective. The criteria are ranked relative to each other, with each criterion having a priority rank indicating the relative importance or necessity of satisfying the criterion. In some embodiments, each objective may also include other information, such as an objective cost function and/or a weight associated with the objective. Objectives, criteria, priority ranks, objective cost functions and weights are discussed in greater detail below.

In some embodiments, the trajectory evaluator 334 receives objective data (e.g., criteria and associated priority ranks, objective cost functions, and/or objective weights) as input at runtime (i.e., when the candidate trajectories are received from the trajectory generator 332) or at load time (i.e., when the planning system 130 is loaded into memory). For example, the objective data may be stored in the memory(ies) of the electronic storage 220 and read by the trajectory evaluator 334 when the motion planner 330 is loaded into memory or when a set of candidate trajectories are received for evaluation. In other embodiments, the objective data may be received as input to the trajectory evaluator 334 at configuration time, i.e. when a human designer configures the trajectory evaluator 334, thereby encoding the objective data into the trajectory evaluator 334 itself (e.g., into the computer-readable instructions implementing the trajectory evaluator 334).

Embodiments of the trajectory evaluator 334 described herein may use objectives to sort trajectories using four different values or functions associated with each objective: criterion satisfaction data indicating a likelihood of a given trajectory satisfying a criterion associated with the objective, a priority rank for the criterion, an objective cost function for the objective, and a weight associated with the objective cost function. These four values or functions are described below.

The priority rank for a criterion may be an integer or other ordinal value indicating the relative priority of each criterion (each criterion being associated with an objective). For example, avoiding a collision (a criterion associated with a safety objective) may be more important than avoiding acceleration or deceleration over a maximum value (a criterion associated with a comfort objective), thereby resulting in the safety-associated criterion having a higher priority than the comfort-associated criterion. It will be appreciated that the term “higher”, in the context of priority ranks, means a priority that is given greater weight or earlier priority in sorting, even if such a priority rank is indicated by a low integer value (e.g., priority rank 1 may indicate a “higher” priority rank than priority rank 2), and the term “lower”, accordingly, has the opposite meaning from “higher” in this context.

Criterion satisfaction data is data associated with a given candidate trajectory which indicates the degree by which a given criterion is satisfied by the given trajectory. For example, the criterion satisfaction data indicates the likelihood that the given candidate trajectory satisfies the criterion (e.g., the collision avoidance criterion). In this context, “likelihood” may refer to a probability value selected from a continuous range of probabilities, to a binary value indicating a yes or no value, or to any other value or function indicating a likelihood or degree by which a trajectory is estimated to satisfy the criterion. For example, some embodiments may generate criterion satisfaction data for a given candidate trajectory with respect to the example safety-associated collision avoidance criterion described above by assigning a binary value of “1” to the criterion information if the given candidate trajectory maintains a distance of 1 meter from all other objects (indicating a probability 1 of satisfying the criterion) and assigning a value of “0” to the criterion information if the given candidate trajectory fails to maintain a distance of at least 1 meter from all other objects (indicating a probability 0 of satisfying the criterion). Other embodiments might assign a continuous probability value to the criterion satisfaction data, such as “0.81” (indicating a probability of 0.81 of satisfying the criterion). For example, in some embodiments the given candidate trajectory may have a value of “1” assigned to the criterion satisfaction data if the given candidate trajectory maintains a distance of more than 1.2 meters from all objects, a value of “0” assigned to the criterion satisfaction data if the given candidate trajectory fails to maintain a distance of at least 0.8 meters from all objects, and a linearly varying value between one and zero assigned to the criterion satisfaction data for maintaining minimum distances from 0.8 to 1.2 meters (e.g., a given candidate trajectory that maintains a minimum distance of 1 meter would have a value of 0.5 assigned to the criterion satisfaction data). In some embodiments, likelihood is indicated by a membership value indicating the extent to which a given candidate trajectory belongs to a given class or set, such as the set of candidate trajectories satisfying a criterion. It will be appreciated that the likelihood values associated with a given candidate trajectory in association with a given criterion (e.g. the membership values for a given candidate trajectory indicating degree of membership in a plurality of classes or sets associated with an objective or criterion) do not need to add up to one (i.e. 100%) in some embodiments. For example, considering two classes of “safe” and “unsafe” in association with a safety criterion or objective, a given candidate trajectory may have a likelihood value of 0.4, indicating a 40% degree of belonging, associated with the “safe” class, and a likelihood value of 0.7, indicating a 70% degree of belonging, associated with the “unsafe” class. However, as described above, some embodiments may use probability values as membership values; in such embodiments, the probability values for each class or set associated with a criterion for a given candidate trajectory would typically add up to 1 (i.e. 100%).

The objective cost function is a cost function that quantifies a cost associated with a given objective, similar to what is used in the conventional rule based approaches to motion planning described above. The degree to which an objective is satisfied is converted into a scalar value representing a cost associated with that objective. For example, a safety objective may be defined as maximizing a distance to a closest object in the traffic environment. The objective cost function for the safety objective may be quantified as 1/d wherein d is the distance to the closest object encountered during the trajectory. An overall cost function factoring in only this single safety objective cost function would result in sorting trajectories to maximize the distance to the closest object maintained during the trajectory.

The weight associated with the objective cost function may also be similar to what is used in the conventional approaches to motion planning described above. The weights associated with a plurality of objective cost functions for a plurality of objectives are used as coefficients that are multiplied by the respective objective costs to generate an overall cost function consisting of, e.g., a weighted sum of individual objectives' cost functions.

Each of these four values or functions is either received as input by the trajectory evaluator 334 or generated by the trajectory evaluator 334 (potentially based on other inputs). For example, in some embodiments the objective data received as input by the trajectory evaluator 334 (as described above) includes, for each objective, one or more criteria associated with the objective (e.g., a safety-related criterion as a minimum distance to other objects of 30 centimeters), a priority rank for each criterion, an objective cost function for computing the objective cost, and a weight associated with the objective cost function. Criterion satisfaction data, indicating whether a given criterion associated with an objective is satisfied by a given candidate trajectory, is generated by the trajectory evaluator 334 based on the objective data, the vehicle state, and the physical parameter of the vehicle 100 described above.

Example embodiments of the trajectory evaluation 334 may first sort candidate trajectories based on the satisfaction of criteria, then perform a further sort of trajectories with similar criterion satisfaction data based on one or more cost functions. Thus, in some embodiments the trajectory sorting operation performed by the trajectory evaluator 334 will search for candidate trajectories that satisfy all of the criterion, then compute the cost of each candidate trajectory using a cost function (e.g., a weighted sum of the objective costs) and perform a further sorting of the candidate trajectories that satisfy all of the criteria based on the lowest computed cost. The trajectory selector 336 will then select a desired trajectory from the candidate trajectories based on the final sort order of the sorted candidate trajectories. If there is no candidate trajectory that satisfies all of the criterion, the criterion having the lowest priority rank is relaxed and the sorting will look for the best candidate trajectory (e.g., lowest-cost trajectory) that satisfies all the criterion except the criterion having the lowest priority rank. The process of relaxing the criterion having the lowest priority rank continues until a best candidate trajectory is found. In some embodiments, if there are not a sufficient number of candidate trajectories that satisfy all of the criterion, the criterion having the lowest priority rank is relaxed and the trajectory generation operation will generate more candidate trajectories until there are sufficient candidate trajectories that satisfy all of the criterion. The process of relaxing the criterion having the lowest priority rank continues until a sufficient number of candidate trajectories that satisfy all of the criterion are generated. It will be appreciated that, in some embodiments, the trajectory sorting operation will still consider the scalar cost of the relaxed objectives when computing the combined weighted value: e.g., even if the criterion associated with a mobility objective has the lowest priority rank, and needs to be relaxed in performing the trajectory sorting operation because no candidate trajectory satisfies all of the criterion, the objective cost associated with the mobility objective will still be factored into the overall cost function in sorting the candidate trajectories.

FIG. 4 is a Venn diagram 400 showing the intersection of various criteria defined by the objective data received by an example trajectory evaluator 334. In this example, the objectives defined by the objective data include, as ordered by the respective priority ranks of the criteria associated with the objectives, a “physical limit” objective, a “no collision” objective, a “safety” objective, a “comfort” objective, and a “mobility” objective. Thus, the criterion associated with the “no collision” objective has the highest priority rank, whereas the criterion associated with the mobility objective has the lowest priority rank. Each objective has an associated criterion, and the subsets of candidate trajectories 402 satisfying each criterion is indicated by the ellipses of the Venn diagram 400: thus, trajectories satisfying the criterion associated with the “physical limit” objective fall within the “physical limit” ellipse 412, and so on for a “no collision” ellipse 414, a “safety” ellipse 416, a “comfort” ellipse 418, and a “mobility” ellipse 420.

In example embodiments, the trajectory evaluator 334 attempts to evaluate and sort the candidate trajectories 402 generated by the trajectory generator 332 to identify a desired trajectory. The identified desired trajectory may be an optimal trajectory or a sub-optimal trajectory. The primary goal is to identify a desired trajectory that satisfies all of the criteria, i.e. a candidate trajectory that falls within first area 422, which is the intersection of each ellipse 412, 414, 416, 418, and 420. If no such candidate trajectory is received from the trajectory generator 332, then a secondary goal of the trajectory evaluator 334 may be to identify a desired trajectory that satisfies all of the criteria other than the criterion having the lowest priority rank, i.e. the mobility criterion represented by mobility ellipsis 420: such a trajectory would fall within second area 424, which is the intersection of each ellipse 412, 414, 416, and 418 but excluding 420. Thus, the criterion having the lowest priority rank, i.e. the mobility-associated criterion, is relaxed if the primary goal cannot be met. Similarly, if no candidate trajectory satisfies the criterion having the next lowest priority rank (i.e. the comfort-associated criterion), then that criterion is also relaxed, and a tertiary goal of the trajectory evaluator 344 is to identify a candidate trajectory satisfying at least the a “physical limit”-associated criterion, the “no collision-associated criterion, and the safety-associated criterion, i.e. a candidate trajectory falling within third area 426 or, preferably, fourth area 428).

It will be appreciated that, in this example Venn diagram 400, satisfying the criterion associated with safety necessarily satisfies the criterion associated with “no collision”, and similarly satisfying the criterion associated with comfort necessarily satisfies the criterion associated with “physical limit”, as shown by the fact that the safety ellipsis 416 is a subset of the “no collision” ellipse 414 and the comfort ellipsis 418 is a subset of the “physical limit” ellipse 412. The relationship between physical limits and comfort may be, for example, a consequence of the “physical limit”-associated criterion being defined by a physical maximum acceleration and physical maximum deceleration of the vehicle 100 as defined by vehicle's physical capabilities (e.g., by the kinodynamic parameters described above with reference to FIG. 1), whereas the comfort-associated criterion may be defined by a maximum comfortable acceleration and maximum comfortable deceleration that are smaller in magnitude than the physical maximum acceleration and physical maximum deceleration. Similarly, the relationship between “safety” and “no collision” may be a consequence of the safety criterion being defined by a minimum safe distance maintained from other objects, whereas the “no collision” criterion is defined by a smaller minimum distance from other objects necessary to prevent actual collision. However, the mobility ellipsis 420 representing the mobility criterion is not a subset of any of the other ellipses shown in the Venn diagram 400. Thus, it will be appreciated that in various embodiments, some criterion associated with some objectives may be more stringent constraints that fall entirely within the bounds of the constraints imposed by other criterion, whereas other criterion will be only partially overlapping, or potentially not overlapping at all in some sets of candidate trajectories 402.

As described above, objective data may define a plurality of objectives that the trajectory evaluator 334 may be configured to consider in evaluating and sorting the candidate trajectories generated by the trajectory generator 332. For each objective defined in the objective data, the objective data may include a priority rank of an associated criterion, definition data for the criterion, an objective cost function, and a weight for the objective cost function in computing an overall cost function. Whereas example embodiments described herein have a single criterion associated with each objective, in some embodiments some objectives may be associated with two or more criterion, and/or some objectives may not be associated with a criterion.

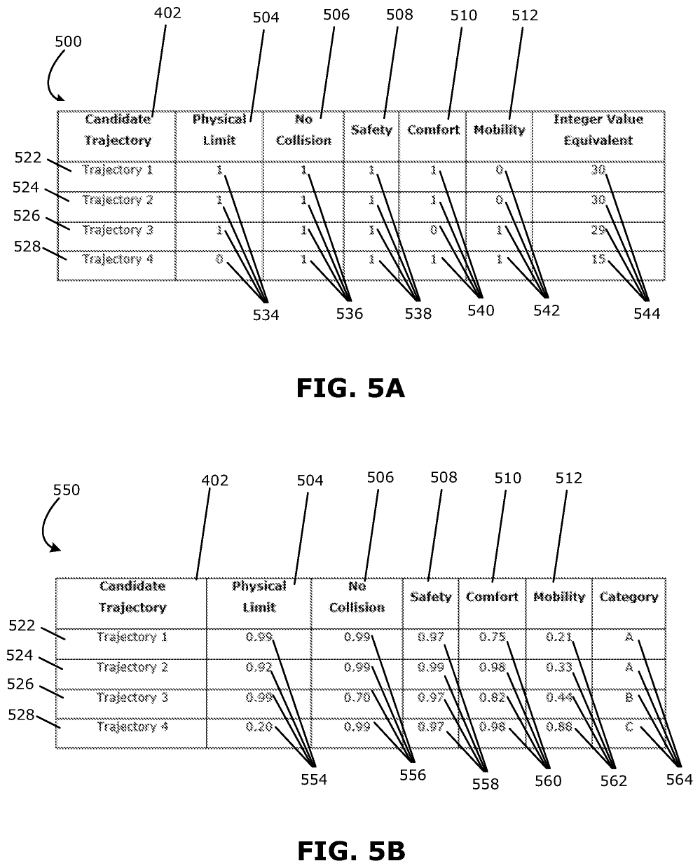

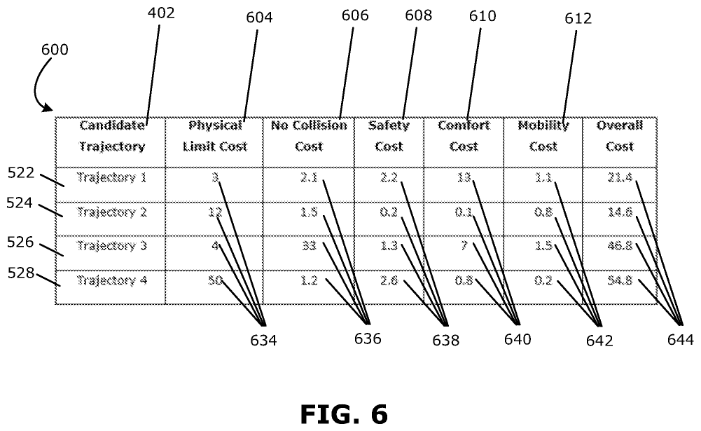

A priority rank may be an integer or other ordinal value, such that a lower (or in some embodiments, higher) value indicates a higher priority rank, as described above with reference to FIG. 3. In some embodiments, two or more criteria included in the objective data may have identical priority ranks, indicating identical priority ranks. However, the embodiments described below all use a strict ranking for priority ranks, as described below with reference to FIGS. 5A-6.

The criteria may be defined in some embodiments with reference to one or more threshold values for a given state variable contained in the vehicle state. For example, a criterion for a safety objective may be satisfied if the distance to the nearest object in a trajectory is greater than a minimum threshold distance, such as 1 meter. The objective data may include definition data for the criterion representing the variable and the threshold value as a function or equation. In some examples, two or more variables may be implicated in the criterion, such that the function or equation may be a non-linear or conditional combination of two or more thresholds or other conditions.

Example criteria definitions may include various state variables. A comfort-associated criterion may constrain vehicle acceleration, deceleration, lateral forces due to turning, smoothness of steering corrections, and so on. A safety-associated criterion may constrain distance to objects in the environment, visibility due to line-of-sight obstructions, maximum vehicle speed, driving on unsafe road surfaces, driving on steep declines, and so on. A mobility-associated criterion may constrain average velocity maintained toward a destination to be above a threshold, distance traveled toward a destination over a time period, and so on. A safety-associated criterion may constrain distance to objects to a greater or more stringent degree than a “no collision”-associated criterion; thus, in some examples the “no collision”-associated criterion may be a relaxed version of the safety-associated criterion. A “physical limit”-associated criterion may constrain vehicle operation by the physical limits of the vehicle 100, such as those defined by the kinodynamic parameters, potentially taking into account environmental state variables such as road conditions. It will be appreciated that existing approaches to trajectory evaluation cost functions provide a range of examples for state variables used to define threshold conditions for various objectives that may be used to define criteria for embodiments described herein.

An objective cost function may be any function that generates a cost based on variables, such as vehicle state and a candidate trajectory. The function may be a linear or a non-linear function that generates a cost based on one or more variables (e.g. vehicle state and candidate trajectory), as described above with reference to FIG. 3. For example, a safety objective cost function might be defined as:

C_{safety}=(distance to closest object along trajectory, in meters)^{-3.5}

Weights may be any linear or non-linear modifier applied to an objective cost function to enable its combination with other objective cost functions to generate an overall cost function used to sort candidate trajectories, as described above with reference to FIG. 3. In some embodiments, weights are constant scalar values used as multipliers to generate an overall cost function consisting of a weighted sum of individual objective costs, such that the weights are used as coefficients multiplying the respective objective costs to generate the weighted sum. In other embodiments, weights may apply a non-linear modifier to an objective cost function, such as an exponential modifier. The overall cost function may combine the weighted objective cost functions for a plurality of objectives through addition or any other means of combination.

Criterion satisfaction data is generated by the trajectory evaluator 334 for each trajectory with respect to a given criterion defined in the objective data. The criterion satisfaction data for a given trajectory indicates a likelihood that the given trajectory satisfies a given criterion defined in the objective data. As described above with reference to FIG. 3, criterion satisfaction data may include a binary value or a continuous membership value indicating the likelihood of the criterion being satisfied by the given trajectory. Examples of criterion satisfaction data are described below with reference to FIGS. 5A-5B.

FIG. 5A shows an example table 500 of criterion satisfaction data for each criterion for four candidate trajectories. The criterion satisfaction data for each criterion is a binary value generated by a first example embodiment of a trajectory evaluator 334. The contents of the table 500 are reproduced below as Table 1, and will be described with reference to the reference numerals of FIG. 5A.

TABLE 1

| | Phys- | No | | | | Integer |
|---|---|---|---|---|---|---|
| Candidate | ical | Colli- | Safe- | Com- | Mobil- | Value |
| Trajectory | Limit | sion | ty | fort | ity | Equivalent |
| Trajectory 1 | 1 | 1 | 1 | 1 | 0 | 30 |
| Trajectory 2 | 1 | 1 | 1 | 1 | 0 | 30 |
| Trajectory 3 | 1 | 1 | 1 | 0 | 1 | 29 |
| Trajectory 4 | 0 | 1 | 1 | 1 | 1 | 15 |

The table 500 shows four candidate trajectories generated by the trajectory generator 332: Trajectory 1 522, Trajectory 2 524, Trajectory 3 526, and Trajectory 4 528. The four trajectories 522, 524, 526, 528 may be simply a small subset of the entire set of candidate trajectories 402 generated by the trajectory generator 332, and are used in this example for the purpose of simplicity and clarity.

Each trajectory 522, 524, 526, 528 is evaluated by the trajectory evaluator 334 with respect to five criteria defined by the objective data: a physical limit criterion 504, a no collision criterion 506, a safety criterion 508, a comfort criterion 510, and a mobility criterion 512. Each criterion 504, 506, 508, 510, 512 is associated with its respective objective in the objective data. The five criteria 504, 506, 508, 510, 512 are shown as columns of the table 500 in order, from left to right, by highest to lowest priority rank of the respective criterion: thus, the physical limit criterion 504 has the highest value and thus the highest priority rank, whereas the mobility criterion 512 has the lowest value and thus the lowest priority rank.

The trajectory evaluator 334 evaluates each trajectory 522, 524, 526, 528 with respect to the five criteria 504, 506, 508, 510, 512 to generate criterion satisfaction data for each trajectory with respect to each criterion. In this example, the criterion satisfaction data for each respective criterion includes a binary value indicating whether the trajectory satisfies the respective criterion (a 1 value) or not (a 0 value). Thus, each trajectory 522, 524, 526, 528 is associated with physical limit criterion satisfaction data 532, no collision criterion satisfaction data 534, safety criterion satisfaction data 538, comfort criterion satisfaction data 540, and mobility criterion satisfaction data 542, each of which is shown as a binary value.

After generating the criterion satisfaction data 534, 536, 538, 540, 544 for each candidate trajectory 522, 524, 526, 528, the trajectory evaluator 334 may sort the candidate trajectories 402 by generating an evaluation value for each trajectory. First, a binary string is generated for each candidate trajectory. The binary string is the binary value of each objective's criterion satisfaction data, ordered by the priority rank of each criterion. Thus, for example, Trajectory 1 522 has a binary string of 11110, whereas Trajectory 4 528 has a binary string of 01111.

Second, the trajectory evaluator 334 generates an integer equivalent value 544 of the binary string. Thus, for example, the integer equivalent value 544 for Trajectory 1 522 is (1*16+1*8+1*4+1*2+0*1=30).

Third, the plurality of candidate trajectories 402 are sorted into ordered categories based on an integer equivalent value 544. In some embodiments, the categories correspond to discrete values of the integer equivalent value 544. Thus, a given integer equivalent value 544, such as 30, corresponds to a single category, whereas any other integer equivalent value 544, such as 29, corresponds to a different category.

In the event that multiple candidate trajectories 402 are sorted into a single category, a further step may be performed to sort the trajectories sharing a common category, as described below with reference to FIG. 6.

In some embodiments, continuous membership values may be used in place of binary (1=yes, 0=no) values for the criterion satisfaction data.

FIG. 5B shows an example table 550 of criterion satisfaction data for each of the four candidate trajectories of FIG. 5A, generated by a second example embodiment of a trajectory evaluator 334 using continuous membership values for criterion satisfaction data. The contents of the table 550 are reproduced below as Table 2, and will be described with reference to the reference numerals of FIG. 5B.

TABLE 2

| | Phys- | No | | | | |
|---|---|---|---|---|---|---|
| Candidate | ical | Colli- | Safe- | Com- | Mobil- | Cate- |
| Trajectory | Limit | sion | ty | fort | ity | gory |
| Trajectory 1 | 0.99 | 0.99 | 0.97 | 0.75 | 0.21 | A |
| Trajectory 2 | 0.92 | 0.99 | 0.99 | 0.98 | 0.33 | A |
| Trajectory 3 | 0.99 | 0.70 | 0.97 | 0.82 | 0.44 | B |
| Trajectory 4 | 0.20 | 0.99 | 0.97 | 0.98 | 0.88 | C |

As in table 500, table 550 shows criterion satisfaction data for each of the same four candidate trajectories 522, 524, 526, 528 with respect to the same five criteria 504, 506, 508, 510, 512. However, the criterion satisfaction data 554, 556, 558, 560, 562 are shown in table 550 as membership values selected from a continuous range of membership values, representing an estimated likelihood that a given trajectory satisfies a given criterion.

This second example embodiment of the trajectory evaluator 334 generating the data of table 550 may define its categories differently from those of the first example embodiment of the trajectory evaluator 334 generating the data of table 500, and may perform sorting differently as well. In some examples, the second example embodiment of the trajectory evaluator 334 uses fuzzy operators to combine the criterion satisfaction data 554, 556, 558, 560, 562 for a trajectory to generate a value which corresponds to a category 564. The fuzzy operators may apply different standards or ranges to the criterion satisfaction data 554, 556, 558, 560, 562 for the various criteria 504, 506, 508, 510, 512 in determining the category 564 for the trajectory. For example, some embodiments may define membership ranges for the various criteria that correspond to equivalent binary values. A range of 0.9 to 1.0 for the physical limit criterion 504 may correspond to a binary 1 value, with the range 0.0 to below 0.9 corresponding to a binary 0 value, such that the physical limit criterion satisfaction data 554 of Trajectory 1 522, Trajectory 2 524, and Trajectory 3 526 have binary “1” value equivalents and the physical limit criterion satisfaction data 554 of Trajectory 4 528 has a binary “0” value equivalent. A range of 0.65 to 1.0 for the no collision criterion 506 may correspond to a binary 1 value, with the range 0.0 to below 0.65 corresponding to a binary 0 value, such that the no collision criterion satisfaction data 556 of Trajectory 1 522, Trajectory 2 524, Trajectory 3 526, and Trajectory 4 528 all have binary “1” value equivalents, and so on. The trajectory sorting operation may then construct a binary number, an integer equivalent value, and a category 564 as described above with reference to FIG. 5A. Table 550 shows categories 564 labelled A, B, and C that correspond to the integer equivalent values 544 of 30, 29, and 15, respectively, from table 500.

In other embodiments, fuzzy operators may combine the continuous membership values of the criterion satisfaction data 554, 556, 558, 560, 562 in more complex and potentially interdependent ways to determine a category 564 for each trajectory 522, 524, 526, 528. In still other embodiments, candidate trajectories may be grouped into categories based on a similarity metric applied to their criterion satisfaction data for each objective. For example, the similarity metric may satisfied for a first candidate trajectory and a second candidate trajectory if, for each objective, the membership value for the first candidate trajectory is within a predetermined similarity range of the membership value for the second candidate trajectory. Thus, for example, the predefined similarity range for the safety objective may be 0.2, in which case all four trajectories 522, 524, 526, 528 would be grouped together into a common category with respect to the safety criterion; but the similarity range of the comfort objective may be 0.1, in which case only Trajectory 2 524 and Trajectory 4 528 would be grouped together, but Trajectory 1 522 and Trajectory 3 526 would each be in a category of its own. Only trajectories sharing a common category for all objectives would be considered to share a common overall category 564.

In some embodiments, the evaluation and sorting of candidate trajectories 402 may be performed in a different order from that described above, and may not be performed in full for all candidate trajectories 402. For example, in some embodiments an initial evaluation and sorting operation may be performed with respect to only one or more criterion having a high priority rank, such as the physical limit criterion 504. Trajectories that, based on their evaluation, fail to satisfy the physical limit criterion 504 may be rejected or filtered out of further processing (e.g., performance of further trajectory evaluation and trajectory sorting operations) if at least one candidate trajectory is identified that does satisfy the physical limit criterion 504. This procedure may be repeated for each other criterion in priority rank order until the only candidate trajectories under consideration are those that are categorized into the highest evaluation value category (e.g., those with integer value equivalent 544 of “30” in table 500, or those in category 564 “A” in table 550).

After the candidate trajectories 402 have been sorted into categories based on their criterion satisfaction data, for example using the techniques described above with reference to FIGS. 5A-5B, some categories may include more than one candidate trajectory. Multiple candidate trajectories within a single category may be sorted with reference to various metrics, such as an overall cost function. An example of sorting trajectories within categories by using a cost function will now be described.

FIG. 6 shows an example table 600 of costs for the four candidate trajectories of FIGS. 5A-5B. The costs are generated by an example embodiment of a trajectory evaluator 334 using a cost function. The contents of the table 600 are reproduced below as Table 3, and will be described with reference to the reference numerals of FIG. 6.

TABLE 3

| | Phys- | No | | | | |
|---|---|---|---|---|---|---|
| | ical | Colli- | Safe- | Com- | Mobil- | Over- |
| Candidate | Limit | sion | ty | fort | ity | all |
| Trajectory | Cost | Cost | Cost | Cost | Cost | Cost |
| Trajectory 1 | 3 | 2.1 | 2.2 | 13 | 1.1 | 21.4 |
| Trajectory 2 | 12 | 1.5 | 0.2 | 0.1 | 0.8 | 14.6 |
| Trajectory 3 | 4 | 33 | 1.3 | 7 | 1.5 | 46.8 |
| Trajectory 4 | 50 | 1.2 | 2.6 | 0.8 | 0.2 | 54.8 |

The trajectory evaluator 334 may employ one or more cost functions to perform a secondary trajectory sorting operation of candidate trajectories 402 within each category (e.g., categories 564) determined in the initial sorting operation described above with reference to FIGS. 5A-5B. In some embodiments, an overall cost function used to perform the trajectory secondary sorting operation is a single, universal cost function that is applied to each category. In other embodiments, different overall cost functions may be used to sort within different categories. After the secondary trajectory sorting operation has been performed, the entire set of candidate trajectories 402 constitutes a sorted plurality of candidate trajectories. The categories are ordered by their satisfaction of the various criteria, as described above, and within each category the trajectories are sorted based on a cost function as described below. Once the secondary trajectory sorting operation has been completed, the trajectory selector 336 may select the first (i.e. lowest-cost) trajectory of the first (i.e. best criteria satisfaction) category for use in commanding the vehicle 100.

In some embodiments, the overall cost function(s) may be based on individual objective cost functions, such as a sum of weighted objective cost functions. In embodiments using a plurality of cost functions for a sorting within a plurality of categories, the weights, objective cost functions, and/or other aspects of the overall cost function used by a given category may differ from those used by the overall cost function of another category.

Thus, in some examples using the objectives corresponding to the criteria 504, 506, 508, 510, 512 shown in FIGS. 5A-5B, an overall cost function may be defined as:

Cₜₒₜₐₗ=Σᵢwᵢ×Cᵢ, f or i∈{physical limit, no collision, safety, comfort, mobility} (Equation 2)

Table 600 of FIG. 6 shows, for each trajectory 522, 524, 526, 528, five objective costs corresponding to the five objectives: a physical limit cost (C_{Physical Limit}) 604, a no collision cost (C_{No Collision}) 606, a safety limit cost (C_{safety}) 608, a comfort cost (C_{Comfort}) 610, and a mobility cost (C_{mobility}) 612. An overall cost function is used to calculate an overall cost 644 for each trajectory 522, 524, 526, 528 based on the objective costs 604, 606, 608, 610, 612 combined with a corresponding set of weights (w_{Physical Limit}, w_{No Collision}, w_{Safety}, w_{Comfort}, w_{Mobility}). In the example shown in table 600, the weights are defined as:

(w_{Physical Limit},w_{No Collision},w_{Safety},w_{Comfort},w_{Mobility})=(100,90,50,20,1) (Equation 3)

Thus, the overall cost (Cₜₒₜₐₗ) 644 is calculated using an overall universal cost function defined as:

Cₜₒₜₐₗ=100×C_{Physical Limit}+90×C_{No Collision}+50×C_{Safety}+20×C_{comfort}+1×C_{Mobility} (Equation 4)

It will be appreciated that the overall cost 644 for each trajectory shown in table 600, if used as the sole basis for sorting the candidate trajectories 402, would result in the trajectories sorted into the following order (from most desirable to least desirable): Trajectory 2 524, Trajectory 1 522, Trajectory 3 526, and Trajectory 4 528. This result is consistent with the two-step sorting operation described above using an initial sorting operation followed by a secondary sorting operation, based on the categorization of the trajectories from either table 500 or table 550, because the two first trajectories in sorted order are Trajectory 1 522 and Trajectory 524, both of which have the same integer equivalent value 544 (i.e. “30”) or are in the same category 564 (i.e. “A”), followed by Trajectory 3 526 (with a lower integer equivalent value 544 or lower-ranked category 564) and then by Trajectory 4 528 (with the lowest integer equivalent value 544 or lowest-ranked category 564). In some embodiments, as in FIGS. 5A-6, the final sort order of the sorted plurality of candidate trajectories resulting from the two-step sorting operation may align with the equivalent result from using the cost function on its own for a one-step sorting operation, and this may be true for embodiments in which a single universal cost function is used, or for embodiments in which category-specific cost functions are used. However, using the two-step sorting operation may enable designers to more clearly identify and separate discrete criteria with distinct priorities that must be fulfilled before other criteria are considered. Furthermore, in some embodiments the two-step sorting operation may allow more efficient use of computing resources by filtering out candidate trajectories that do not satisfy high-priority criteria (i.e. criteria having high priority rank) at an early processing stage.

In other embodiments, a single-step sorting operation using the cost function alone may result in a different sort order from the two-step sorting operation described above.

The two-step sorting operation using the first example embodiment with the data values shown in table 500 and a cost function as shown in table 600 may therefore be represented in pseudo-code as follows:

Given trajectories tr1 and tr2:

```
If tr1.priority > tr2.priority then tr1 > tr2
Else if tr1.priority < tr2.priority then tr2 < tr1
Else (tr1.priority == tr2.priority)
  If tr1.value > tr2.value then tr1 > tr2
  Else if tr1.value < tr2.value then tr2 > tr1
  Else tr2 == tr1
```

wherein ‘tr1.priority’ is the integer equivalent value 544 of the binary string corresponding to the criteria that are satisfied in trajectory tr.1, and ‘tr1.value’ is the overall cost 644 for trajectory tr.1.

In some embodiments, the trajectory evaluator 334 may perform the trajectory evaluation and trajectory sorting operations described above in conjunction with the trajectory generation operation performed by the trajectory generator 332. Trajectory generation, evaluation, and sorting operations can be performed in an iterative process, wherein the trajectory generation operation is refined based on the results of the trajectory evaluation and trajectory sorting operations. For example, the trajectory generator 332 may generate an initial set of candidate trajectories, which are then evaluated and sorted by the trajectory evaluator 334 (e.g., either a full two-step sorting operation or simply the initial sorting operation using criteria and not a cost function). The results of the sorting operation are then provided to the trajectory generator 332, which is configured to generate a second set of candidate trajectories, which are limited to trajectories similar to those determined by the trajectory evaluator 334 to satisfy various criteria and/or have low costs.

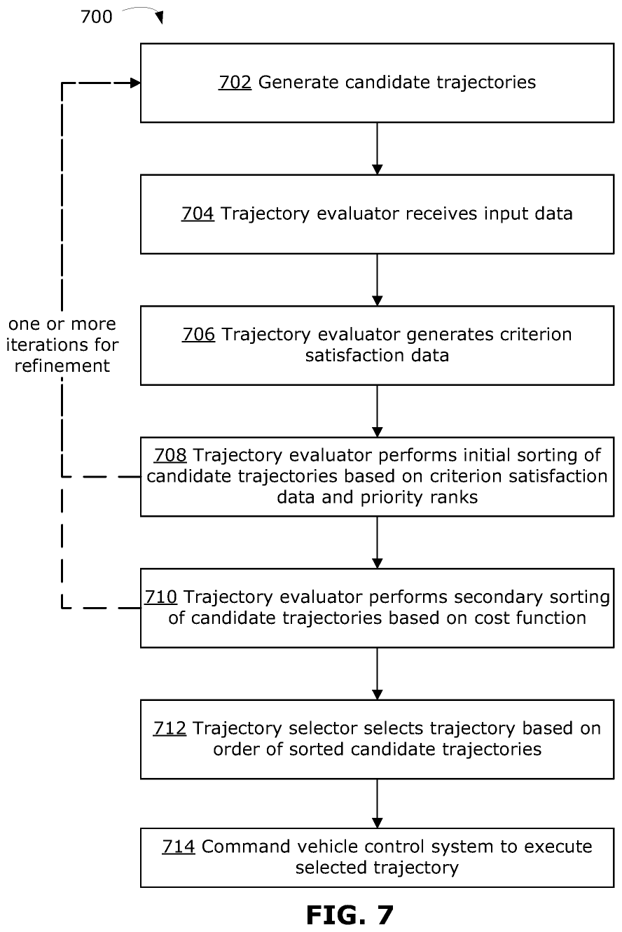

FIG. 7 shows steps of an example method 700 for selecting a trajectory for an autonomous vehicle. The steps of the method 700 are described with reference to the example autonomous vehicle 100 and motion planner 330 described above and their sub-components; however, it will be appreciated that in some embodiments the method 700 may be carried out by other elements of an autonomous vehicle or an associated computing system.

The method 700 generally begins with trajectory generation, followed by trajectory evaluation, then initially sorting the trajectories according to their criterion satisfaction data, then sorting within the categories assigned by the initial trajectory sorting operation based on a cost function, then trajectory selection based on the sorted order of the candidate trajectories, then commanding the autonomous vehicle to execute the selected trajectory.

At 702, a plurality of candidate trajectories 402 are generated by the trajectory generator 332. This step may be performed as described above with reference to FIG. 3.

At 704, the trajectory evaluator 334 receives input data. The input data includes objective data and the plurality of candidate trajectories 402 generated at step 702. The input data may also include the vehicle state generated by the state generator 125.

The objective data includes, for each of a plurality of objectives, at least a criterion related to the objective and a priority rank for the criterion. The criterion may be a definition for a criterion as described above, e.g. a threshold for a state variable. The priority rank may be as described above, i.e. an ordinal value ranking the priority of the criterion relative to the other criteria.

At 706, for each objective, the trajectory evaluator 334 generates criterion satisfaction data for each candidate trajectory. The criterion satisfaction data indicates a likelihood that the candidate trajectory satisfies the criterion, as described above. As described above, in some embodiments (such as the first example embodiment used to generate table 500) the criterion satisfaction data for each objective includes a binary value selected from a first value (e.g., 1) indicating that the criterion is satisfied, and a second value (e.g., 0) indicating that the criterion is not satisfied. In other embodiments (such as the second example embodiment used to generate table 550) the criterion satisfaction data for each objective includes a membership value selected from a continuous range of membership values.

At 708, an initial sorting step is performed by the trajectory evaluator 334 to sort the candidate trajectories 402 into categories based on their respective criterion satisfaction data. The plurality of candidate trajectories are initially grouped into ordered categories based on the criterion satisfaction data and the priority rank for each criterion. The initial sorting into ordered categories may be performed based on a similarity metric: if the criterion satisfaction data of two candidate trajectories satisfies the similarity metric, they are grouped into the same category.

In some embodiments using binary values for the criterion satisfaction data, the similarity metric is satisfied only by identical binary values for all objectives (i.e., each distinct binary number corresponds to a distinct category). Thus, for each candidate trajectory, a binary number is generated, comprising the binary value of each objective's criterion satisfaction data, ordered by the priority rank of each criterion. The plurality of candidate trajectories 402 are then sorted into ordered categories based on the integer equivalent value 544 of the binary number.

In some embodiments using continuous membership values for the criterion satisfaction data, the similarity metric is satisfied for a first candidate trajectory and a second candidate trajectory if, for each objective, the membership value for the first candidate trajectory is within a predetermined similarity range of the membership value for the second candidate trajectory.

Other possible similarity metrics, categorization processes, and initial trajectory sorting operations are described above with reference to FIGS. 5A-5B.

Example criteria used in the initial sorting step 708 may be as described in detail above. The plurality of objectives received in the objective data may include a safety objective having an associated criterion described as including a minimum safe distance to an object. The plurality of objectives received in the objective data may include a comfort objective having an associated criterion described as including a maximum acceleration and a maximum deceleration. The plurality of objectives received in the objective data may include a mobility objective having an associated criterion described as including a minimum distance travelled toward a destination. Other criteria and objectives, such as a no collision objective, a physical limit objective, other objectives, and their associated criteria, may include others as described above.

Following the initial sorting step 708, the method 700 may in some embodiments loop back to step 702 to generate a refined further set of candidate trajectories, as described above, thereby performing an iterative refinement of the set of generated trajectories. This looping back may be performed one or more times to refine the trajectories before a final iteration of the initial sorting step 708 results in the method 700 proceeding to step 710. (This looping behavior is optional, indicated as a dashed line in FIG. 7.)

At 710, the sorted plurality of candidate trajectories are further ordered based on a cost value generated by applying a cost function to each candidate trajectory. In some embodiments, each pair of candidate trajectories is sorted relative to each other based on the cost function applied to each of the two candidate trajectories. Thus, if the criterion satisfaction data of two candidate trajectories satisfies a similarity metric such that they are grouped together at initial sorting step 708, at step 710 the two candidate trajectories are sorted relative to each other based on the cost function applied to each of the two candidate trajectories. In other embodiments, in which the initial sorting step 708 sorts the candidate trajectories 402 into categories, step 710 sorts the candidate trajectories within each category based on the cost function.

In some embodiments, the trajectory evaluator 334 applies a single universal cost function. In other embodiments, the trajectory evaluator 334 applies a cost function selected from a plurality of cost functions based on the criterion satisfaction data. Examples of each approach are described in detail above with reference to FIG. 6.

By performing initial sorting step 708 followed by secondary sorting step 710, the trajectory evaluator 334 thus sorts the plurality of candidate trajectories 402 to generate a sorted plurality of candidate trajectories.

Following the secondary sorting step 710, the method 700 may in some embodiments loop back to step 702 to generate a refined further set of candidate trajectories, as described above, thereby performing an iterative refinement of the set of generated trajectories. This looping back may be performed one or more times to refine the trajectories before a final iteration of the secondary sorting step 710 results in the method 700 proceeding to step 712. (This looping behavior is optional, indicated as a dashed line in FIG. 7.)

At 712, the trajectory selector 336 selects a candidate trajectory as a desired trajectory based on the order of the sorted plurality of candidate trajectories. Trajectory selection is described above with reference to FIG. 3.

At 714, the vehicle control system 140 of the autonomous vehicle 100 is commanded to execute the selected trajectory. This is the final step of the method 700.

Whereas the example embodiments disclosed herein are described in the context of autonomous vehicles and trajectory evaluation, sorting, and selection operations, it will be appreciated that the embodiments described herein may be applied more broadly in other areas of optimization. The general approach of using easily-defined, distinct criteria as hard constraints in combination with more amorphous, interdependent, complex objectives as soft constraints factored into a cost function may be applied to optimize sorting and selection of different options in other problem domains. The proposed approach is thus potentially a general approach for any multi-objective optimization. The approach can also be applied to multi-objective constrained optimization problems to find a suboptimal solution if there is no solution satisfying all of the constraints. In this case, if a set of priorities can be assigned to the constraints, the constraints can be relaxed one-by-one based on their priorities to find a suboptimal solution. While the proposed approach is designed with challenges in motion planning in mind, it can be applied to other domains where similar issues are present and a multi-objective optimization algorithm is needed. In particular, the described two-step sorting operation may be useful in situations wherein an objective cannot be easily translated to a quantitative value (e.g., a cost function); wherein there are many objectives, and taking into account the effect of all cost functions simultaneously in various conditions is cumbersome or impractical; and/or wherein definite, consistent guarantees for certain behavior in certain conditions are required.

Although examples have been described in the context of autonomous vehicles, it should be understood that the present disclosure is not limited to autonomous vehicles. For example, any vehicle that includes advanced driver-assistance system for a vehicle that includes a planning system may benefit from a motion planner that performs the trajectory generation, trajectory evaluation, trajectory selection operations of the present disclosure. Further, any vehicle that includes an automated driving system that can operate a vehicle fully autonomously or semi-autonomously may also benefit from a motion planner that performs the trajectory generation, trajectory evaluation, trajectory selection operations of the present disclosure. A planning system that includes the motion planner of the present disclosure may be useful for enabling a vehicle to navigate a structured or unstructured environment, with static and/or dynamic obstacles.

Although the present disclosure describes methods and processes with operations in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A system for selecting a trajectory for an autonomous vehicle, the system comprising a processing system configured to execute instructions to cause the system to:
receive:
a plurality of candidate trajectories; and
for each of a plurality of objectives:
a criterion related to the objective; and
a priority rank for the criterion;
for each objective, generate criterion satisfaction data for each candidate trajectory, the criterion satisfaction data indicating a likelihood that the candidate trajectory satisfies the criterion;
sort the plurality of candidate trajectories to generate a sorted plurality of candidate trajectories, the sorted plurality of candidate trajectories being ordered based on the criterion satisfaction data and priority rank for each criterion; and
select a candidate trajectory based on the order of the sorted plurality of candidate trajectories.

2. The system of claim 1, wherein the sorted plurality of candidate trajectories are further ordered based on a cost value generated by applying a cost function to each candidate trajectory.

3. The system of claim 2, wherein the plurality of candidate trajectories are sorted by:
sorting the plurality of candidate trajectories based on the criterion satisfaction data and priority rank of each criterion; and
if the criterion satisfaction data of two candidate trajectories satisfies a similarity metric, sorting the two candidate trajectories relative to each other based on the cost function applied to each of the two candidate trajectories.

4. The system of claim 3, wherein the criterion satisfaction data for each objective comprises a binary value selected from:
a first value indicating that the criterion is satisfied; and
a second value indicating that the criterion is not satisfied.

5. The system of claim 4, wherein the similarity metric is satisfied only by identical binary values for all objectives.

6. The system of claim 4, wherein the plurality of candidate trajectories are sorted by:
generating, for each candidate trajectory, a binary number comprising the binary value of each objective's criterion satisfaction data, ordered by the priority rank of each criterion;
sorting the plurality of candidate trajectories into ordered categories based on an integer equivalent value of the binary number; and
sorting the candidate trajectories within each category based on the cost function.

7. The system of claim 3, wherein the criterion satisfaction data for each objective comprises a membership value selected from a continuous range of membership values.

8. The system of claim 7, wherein the similarity metric is satisfied for a first candidate trajectory and a second candidate trajectory if, for each objective, the membership value for the first candidate trajectory is within a predetermined similarity range of the membership value for the second candidate trajectory.

9. The system of claim 2, wherein the cost function comprises a single universal cost function, the single universal cost function comprising a weighted sum of a plurality of objective costs, each objective costs being associated with one of the plurality of objectives.

10. The system of claim 2, wherein the cost function comprises a cost function selected from a plurality of cost functions based on the criterion satisfaction data.

11. The system of claim 1, wherein:
the plurality of objectives includes a safety objective; and
the criterion of the safety objective comprises a minimum safe distance to an object.

12. The system of claim 1, wherein:
the plurality of objectives includes a comfort objective; and
the criterion of the comfort objective comprises a maximum acceleration and a maximum deceleration.

13. The system of claim 1, wherein:
the plurality of objectives includes a mobility objective; and
the criterion of the mobility objective comprises a minimum distance travelled toward a destination.

14. A method for selecting a trajectory for an autonomous vehicle, the method comprising:
receiving:
a plurality of candidate trajectories; and
for each of a plurality of objectives:
a criterion related to the objective; and
a priority rank for the criterion;
for each objective, generating criterion satisfaction data for each candidate trajectory, the criterion satisfaction data indicating a likelihood that the candidate trajectory satisfies the criterion;
sorting the plurality of candidate trajectories to generate a sorted plurality of candidate trajectories, the sorted plurality of candidate trajectories being ordered based on the criterion satisfaction data and priority rank for each criterion; and
select a candidate trajectory based on the order of the sorted plurality of candidate trajectories.

15. The method of claim 14, wherein the plurality of candidate trajectories are sorted by:
sorting the plurality of candidate trajectories based on the criterion satisfaction data and priority rank of each criterion; and
if the criterion satisfaction data of two candidate trajectories satisfies a similarity metric, sorting the two candidate trajectories relative to each other based on a cost function applied to each of the two candidate trajectories.

16. The method of claim 15, wherein the criterion satisfaction data for each objective comprises a binary value selected from:
a first value indicating that the criterion is satisfied; and
a second value indicating that the criterion is not satisfied.

17. The method of claim 16, wherein the plurality of candidate trajectories are sorted by:
generating, for each candidate trajectory, a binary number comprising the binary value of each objective's criterion satisfaction data, ordered by the priority rank of each criterion;
sorting the plurality of candidate trajectories into ordered categories based on an integer equivalent value of the binary number; and
sorting the candidate trajectories within each category based on the cost function.

18. The method of claim 15, wherein the criterion satisfaction data for each objective comprises a membership value selected from a continuous range of membership values.

19. The method of claim 15, wherein the cost function comprises a cost function selected from a plurality of cost functions based on the criterion satisfaction data.

20. A computer-readable medium storing instructions for execution by a processing system of a system for selecting a trajectory for an autonomous vehicle, the instructions when executed causing the processing system to:
receive:
a plurality of candidate trajectories; and
for each of a plurality of objectives:
a criterion related to the objective; and
a priority rank for the criterion;
for each objective, generate criterion satisfaction data for each candidate trajectory, the criterion satisfaction data indicating a likelihood that the candidate trajectory satisfies the criterion;
sort the plurality of candidate trajectories to generate a sorted plurality of candidate trajectories, the sorted plurality of candidate trajectories being ordered based on the criterion satisfaction data and priority rank for each criterion; and
select a candidate trajectory based on the order of the sorted plurality of candidate trajectories.
